(19) United States
(12) Patent Application Publication
(10) Pub. No.: US 2021/0171244 A1
(43) Pub. Date: Jun. 10, 2021

(54) THERMAL CUP

(71) Applicant: Jingtao TAN, Loudi, Hunan (CN)

(72) Inventor: Jingtao TAN, Loudi, Hunan (CN)

(21) Appl. No.: 16/706,708

(22) Filed: Dec. 7, 2019

(51) Int. Cl. B65D 43/26; B65D 51/24; B65D 43/02; B65D 51/16; B65D 51/18

(52) U.S. Cl. CPC B65D 43/26; B65D 51/242; B65D 43/0231; B65D 2251/0018; B65D 51/18; B65D 2251/0081; B65D 51/1688

(57) ABSTRACT

The present invention discloses a thermal cup, which includes a cup body with an opening and a cover, a promoter, a sealing ring and a driver. The cover is covered to the opening. The driver is installed on the top face of the cover, the promoter is installed on the bottom face of the cover, when the cover covers at the opening, the promoter is inside the opening, and a gap is formed among the opening, the top wall of the cover and the promoter, the sealing ring is accommodated in the gap. When close the cover, the driver is rotated to bring the promoter to move upwards, the gap is reduced and the sealing ring seals the gap; when open the cover, the driver is rotated to bring the promoter to move downwards, the sealing ring resets to break the sealed connection of the opening and the cover.

### TECHNICAL FIELD

The invention relates to cup technical field, more specifically, to a thermal cup.

### BACKGROUND OF THE INVENTION

Cups are essential for daily drinking water. At present, most of the heat preservation cups include a cup body and a cover that covers the opening of the cup body; a sealing ring is arranged in the cover, the cover is connected with the opening in threaded connection, so that the sealing ring is pressed between the opening and the cover to preserve heat in the cup body. However with threaded connection, the users have to rotate the cover for a plurality of turns to open or close the cover, it brings great inconvenience. And, when the pressure inside the cup is greater than or less than the external pressure, the threaded connection of the opening and the cover will be strengthen, it takes very vigorous power to turn the cover and open it, it is inconvenient. In some of the heat preservation cups, the cover is fastened and clamped with the cover. Although the cover is easy to open, the sealing performance is worse, it results in poor heat preservation effect.

### SUMMARY OF THE INVENTION

The objection of the present invention is to provide a thermal cup, which aims at solving the technical problem that the cover and the opening of the cup body are connected in threaded connection in the prior art, the user must rotate the cover multiple times for opening or closing it, which brings great inconvenience.

In order to achieve the above object, the invention provides a thermal cup, which includes a cup body with an opening and a cover with a side wall and a top wall and covered the opening, the top wall has an upper face and a bottom face.

The thermal cup also includes a driver installed on the upper face of the top wall of the cover, a promoter installed on the bottom face of the top wall of the cover and a sealing ring made of elastic material and arranged between the cover and the promoter. The promoter passes through the top wall to connect with the driver.

When the cover covers at the opening, the promoter is inside the opening, and a gap is formed among its inner wall of the opening, the top wall of the cover and the promoter, the sealing ring is accommodated in the gap; when it needs to close the cover, the driver is rotated to bring the promoter to move upwards, the gap is reduced and the sealing ring is bent to seal the gap so that the cover and the opening are sealed connection; when it needs to open the cover, the driver is rotated reversely to bring the promoter to move downwards, the sealing ring elastically resets to break the sealed connection of the opening and the cover.

The sealing ring includes a first annular connecting portion which is connected with the bottom face of the top wall of the cover, the first annular connecting portion extends downward to form a first annular sealing portion, and its outer diameter of the promoter is gradually reduced from its bottom to its top to form a tapered pushing portion, the tapered pushing portion contacts with its inner side of the first annular sealing portion; the first annular sealing portion is bent under push of the tapered pushing portion to seal the gap.

Its outer wall of the first annular sealing portion is provided with a first sealing groove, and its inner wall of the opening is provided with an arc-shaped convex part; the first sealing groove is sealed connection with the arc-shaped convex part under push of the tapered pushing portion.

Its top of the sealing ring is provided with a first annular connecting groove, its top wall of the cover is provided with a first annular connecting projection inserted the first annular connecting groove.

The sealing ring includes a second annular connecting portion which contacts to the bottom face of the top wall of the cover; the second annular connecting portion extends downward to form a second annular sealing portion; the promoter has a connecting portion; the second annular sealing portion is adapted to the connecting portion; the second annular sealing portion is bent under push of the promoter to seal the gap.

Its lower end of the second annular sealing portion is provided with a second annular connecting protrusion; the promoter has a stepped groove outside the connecting portion; the second annular connecting protrusion is inserted the stepped groove with its interference fit.

Its top of the first annular connecting portion extends outwards to form an annular sealing table, its top face of the annular sealing table contacts with the bottom face of the top wall of the cover; when the cover covers the opening, its bottom face of the ring sealing table contacts with the opening.

At least one elastic member is arranged between the bottom top wall of the cover and the promoter.

The driver has a driving plate, one end of the driving plate is provided with two mounting seats enclosed by a connecting plate and two side plates arranged on both sides of the connecting plate; the two side plates are provided with a pair of eccentrical holes; a shaft is inserted the pair of eccentrical holes and arranged in parallel with the driving plate; one side of two side plates is far to the shaft to form a distal shaft side, the other side of the two side plates is near to the shaft to form a near shaft side; the promoter is provided with two pushing rods, and its upper portion of the pushing rod is provided with a hole; the shaft is rotatably connected to the hole; when it is need to lock the cover, the driving plate is rotated down to drive the distal shaft side to contact with the top face of the cover, so that the pushing rods is moved upward to push the sealing ring to seal the gap; when it needs to open the cover, the driving plate is rotated upward to drive the near shaft side to contact with the top face of the cover, so that the pushing rod is moved downward, the sealing ring resets, thereby unlocking the sealed connection of the cup body and the cover.

The distal shaft face and the near shaft face are perpendicular to each other; the distal shaft side is parallel to the driving plate, and the near shaft side is perpendicular to the driving plate.

The top wall of the cover is depressed to form a receiving groove, and the receiving groove is provided with a first step groove and a second step groove slot arranged up and down; the second step groove is provided with two through holes; the upper portions of the pushing rods are respectively movable through the two through holes and rotatably connected to the shaft.

The driving plate is semicircular, and the driving plate is provided with a circular or elliptical through hole.

The promoter is provided with at least one pushing rod at its upper end, the pushing rod is movable through the cover to connect with the driver.

Its middle of the promoter is provided with a one-way exhaust valve.

The thermal cup also includes an outer cover, the outer cover is covered to the cup body, and the cover is located within the outer cover.

The thermal cup in the present invention has the following advantages: the cover is covered on the opening of the cup body, the driver brings the promoter up to reduce the gap among the opening and the promoter. The sealing ring is bent under the push of the promoter to completely fill with the gap, so that the opening and the cover are sealed connection, and the inside of the cup body is sealed. Similarly, the driver brings the promoter down to increase the gap between the opening and the promoter, the sealing ring resets to unlock the sealed connection of the opening and the cover. Therefore, the cover can be locked by rotating the driving plate downwards and be opened by rotating the driving plate upwards. It is very convenient to open and close the cover. The thermal cup is solved the disadvantages of the prior art.

### BRIEF DESCRIPTION OF THE DRAWINGS

In order to explain more clearly the technical proposals in the embodiment of the invention, the following will briefly introduce the drawings that need to be used in the embodiment or the prior art description. It is obvious that the drawings in the following description are only some embodiments of the invention, and for the ordinary technical personnel in the field, other drawings can be obtained according to these drawings without paying creative labor.

FIG. 1 is a section view of the thermal cup according to the present invention.

FIG. 2 is a section view of the sealing ring of the thermal cup according to the present invention.

FIG. 3 is an exploded view of the thermal cup according to the present invention.

FIG. 4 is a locking state view of the cover of the thermal cup according to the present invention.

FIG. 5 is an unlocking state view of the cover of the thermal cup according to the present invention.

FIG. 6 is a section view of the thermal cup according to the present invention.

FIG. 7 is a section view of another sealing ring of the thermal cup according to the present invention.

### DETAILED DESCRIPTION OF EMBODIMENTS

Embodiments of the present invention are described in detail below, and an example of the embodiment is shown in the attached drawings, in which the same or similar label represents the same or similar element or element with the same or similar function. The embodiments described below by reference to the attached drawings are exemplary and are intended to explain embodiments of the present invention and cannot be understood as restrictions in the present invention.

In the description of embodiments of the present invention, it is important to understand that the azimuth or position relationships indicated by the terms “length”, “width”, “upper”, “lower”, “front”, “rear”, “left”, “right”, “vertical”, “horizontal”, “top”, “bottom”, “inside”, “outside”, etc., are based on the azimuth or position relationship shown in the attached figure only to facilitate the description and simplification of the embodiment of the invention, Instead of indicating or implying that the device or element must have a specific azimuth, constructed and operated in a specific azimuth, it cannot be understood as a limitation on the present invention.

In addition, the terms “the first”, “the second” are for descriptive purposes only and are not to be construed as indicating or implying a relative importance or implicitly indicating the number of technical features indicated. Thus, the characteristics of “the first” and the “the second” are defined, which may include one or more of the features either explicitly or implicitly. In the description of embodiments of the invention, the “multiple” has the meaning of two or more, unless specifically defined otherwise.

In the embodiment of the invention, unless otherwise specified and limited, the terms “install”, “connect”, “fix” and other terms should be understood in a broad sense, for example, it can be a fixed connection, a detachable connection, or a whole, which can be a mechanical connection or an electric connection. It can be directly connected or indirectly connected by intermediate medium, which can be the internal connection of two components or the interaction between two components. For ordinary technical personnel in the field, the specific meaning of the above terms in embodiments of the present invention can be understood according to the specific circumstances.

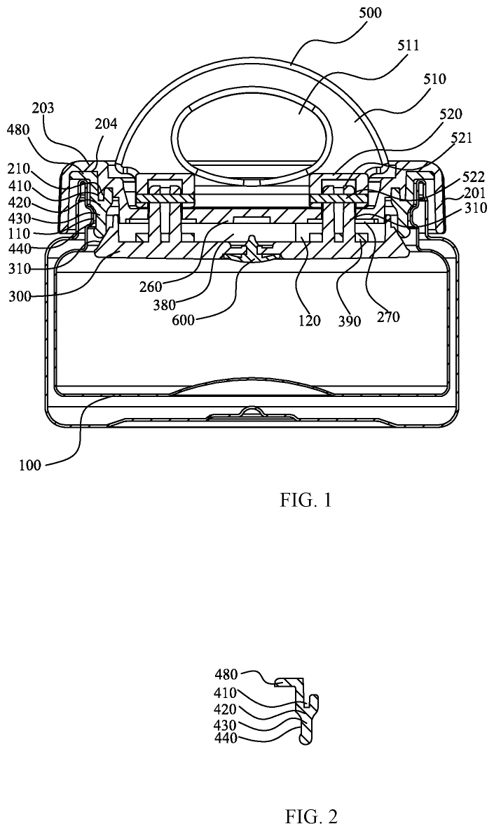

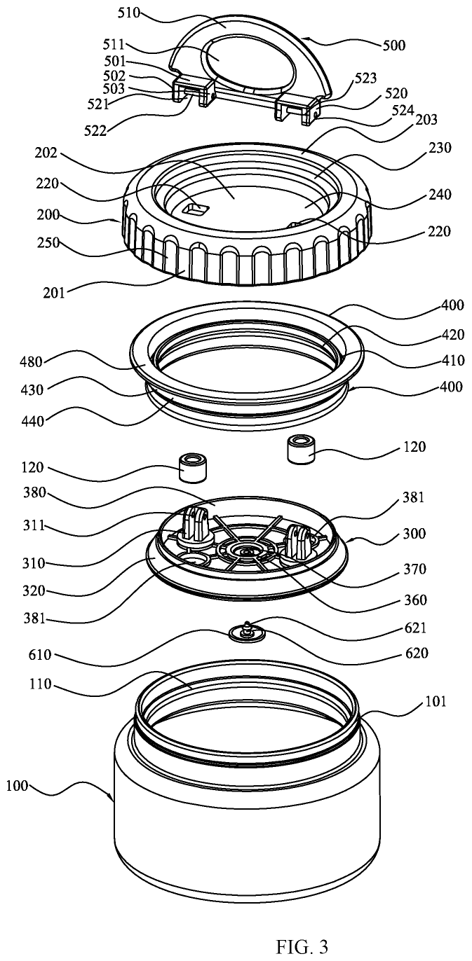

Referring to FIG. 1 and FIG. 3, the present invention discloses a thermal cup, which includes a cup body 100 with an opening 101, a cover 200 with a side wall 201 and a top wall 203 and covered the opening 101, a promoter 300, a sealing ring 400 and a driver 500. The top wall 203 has a top face and a bottom face 204.

Referring to FIG. 1, the cover 200 covers the opening 101 of the cup body 100. The driver 500 is installed on the top face of the top wall 203 of the cover 200, the promoter 300 is installed on the bottom face of the top wall 203 of the cover 200. The promoter 300 passes through the top wall 203 to connect with the driver 500. Specifically, the promoter 300 is provided with at least a pushing rod 310 at its upper end. The pushing rod 310 is movable through the cover 200 to connect with the driver 500. The sealing ring 400 is made of elastic material and arranged between the cover 200 and the promoter 300.

Specifically, the cup body 100 is a double-layer structure, which is beneficial to the internal heat preservation. Referring to FIG. 3, the cover 200 is a groove enclosed by the side wall 201 and the top wall 203. When the cover 200 covers the opening 101, the opening 101 lies inside the side wall 201. A gap is formed among the opening 101, the top wall 203 of the cover 200 and the promoter 300, the sealing ring 400 is located in the gap.

Preferably, the middle of the top wall 203 is depressed to form a bottom face of a receiving groove 202. The side wall 201 is provided with a plurality of vertical grooves 250 which is convenient for the user to grasp the cover 200.

Referring to FIG. 1, the driver 500 is installed in the receiving groove 202, the promoter 300 is installed under the bottom face of the receiving groove 202. The pushing rod 310 is movable through the bottom face of the receiving groove 202 to connect with the driver 500. When the cover 200 covers the opening 101 of the cup body 100, the opening 101 lies between the receiving groove 202 and the side wall 201, the promoter 300 are located in the opening 101 of the cup body 100. The gap is formed among the opening 101, the receiving groove 202 and the promoter 300, the sealing ring 400 is located in the gap.

Referring to FIG. 1 and FIG. 2, its top of the sealing ring 400 is provided with a first annular groove 410, the bottom face 204 of the top wall 203 of the cover 200 is provided with a first annular protrusion 210, the first annular protrusion 210 is inserted the first annular groove 410 with its interference fit so that the sealing ring 400 is stably connected with the top wall 203 of the cover 200.

Referring to FIG. 1, FIG. 2 and FIG. 3, the sealing ring 400 includes a first annular connecting portion 420. Its top of the first annular connecting portion 420 is provided with the first annular groove 410. The first annular connecting portion 420 extends downward to form a first annular sealing portion 430. And the outer diameter of the promoter 300 is gradually reduced from its bottom to its top to form a tapered pushing portion 320 that is in contact with the inner side of the first annular sealing portion 430. The driver 500 drives the tapered pushing portion 320 of the promoter 300 to move up, thereby reducing the gap among the opening 101, the cover 200 and the promoter 300. The first annular sealing portion 430 is bent under the push of the tapered pushing part 320 to seal the gap, so that the opening 101 and the cover 200 are sealed connection, and the inside of the cup body 100 is sealed, thereby realizing heat preservation. Similarly, the driver 500 drives the tapered pushing portion 320 of the prompter 300 to move down, the gap among the opening 101, the cover 200 and the prompter 300 increases, the first annular sealing portion 430 resets to unlock the sealing connection of the opening 101 and the cover 200.

Preferably, the outer wall of the first annular sealing portion 430 is provided with a first sealing groove 440, and its inner wall of the opening 101 of the cup body 100 is provided with an arc-shaped convex part 110. The first sealing groove 440 is sealed and clamped with the arc-shaped convex part 110 under the push of the tapered pushing portion 320, so that the sealing effect is better.

Referring to FIG. 1, FIG. 2 and FIG. 3, the top of the first annular connecting portion 420 extends outwards to form the annular sealing table 480, and the top face of the annular sealing table 480 contacts with the bottom face of the top wall of the cover 200. When the cover 200 covers the opening 101, the bottom face of the ring sealing table 480 is sealed with the opening 101, so that the sealing effect is better.

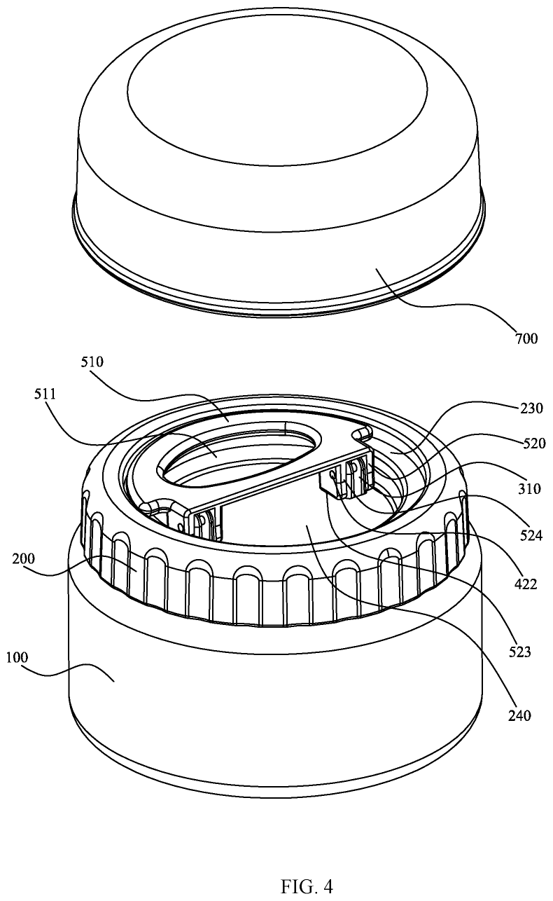

Referring to FIG. 3 and FIG. 4, the driver 500 has a driving plate 510. One end of the driving plate 510 is provided with two mounting seats 520, The mounting seat 520 has a connecting plate 501 and two side plates 502 and 503 arranged on both sides of the connecting plate 501. Each of the mounting seats 520 is provided with an installing slot 521, the two side plates are provided with a pair of eccentrical holes. A shaft 522 is inserted the pair of eccentrical holes and arranged in parallel with the driving plate 510. So that one side of two side plates, far to the shaft 522, forms a distal shaft side 523, the other side of the two side plates, near to the shaft 522, forms a near shaft side 524. Preferably, the distal shaft side 523 and the near shaft side 524 are perpendicular to each other. The distal shaft side 523 is arranged parallel to the driving plate 510, and the near shaft side 524 is arranged perpendicular to the driving plate 510.

Referring to FIG. 3, its upper end of the promoter 300 is symmetrically provided with two of the pushing rods 310, and the upper portions of the two pushing rod 310 are provided with a hole 311 respectively. The bottom face of the receiving groove 202 is provided with a pair of through holes 220. The upper portions of the two pushing rods 310 are respectively movable through the through holes 220, and the two shafts 522 are respectively rotatably connected to the holes 311.

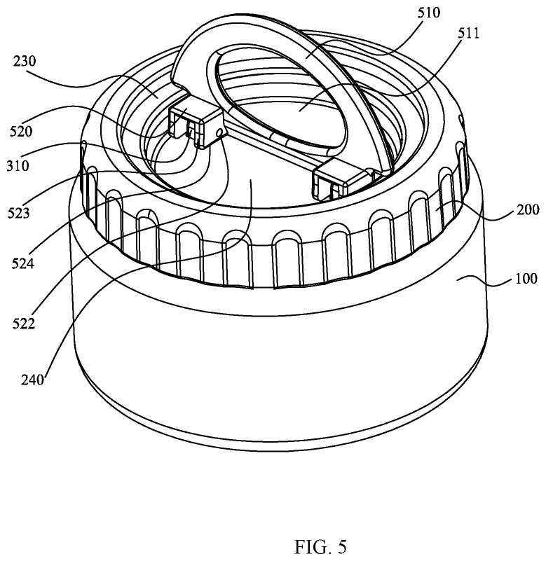

Reference FIG. 1 and FIG. 4, when it needs to lock the cover 200, the driving plate 500 is rotated down to drive the distal shaft side 523 to contact with the bottom face of the receiving groove 201, so that the two pushing rods 310 is moved upward to push the sealing ring 400 to seal the gap, thereby the cup body 100 and the cover 200 are connected in a seal way. Reference FIG. 1 and FIG. 5, when it needs to open the cover 200, the driving plate 500 is rotated up to drive the near shaft side 524 contact with the bottom face of the receiving groove 201, so that the two pushing rods 310 is moved downward, thereby unlocking the sealed connection of the cup body 100 and the cover 200. Then the covers 200 can be taken off from the cover 200.

In the present invention, the cover 200 can be locked with rotating down the driving plate 510 and opened with rotating up the driving plate 510. It is very convenient and solves the problems of the prior art that the cover and the cup body are connected in threaded way.

Referring FIG. 4, the receiving groove 202 has a first step slot 230 and a second step slot 240 arranged up and down. Preferably, the first step slot 230 and the second step slot 240 are cylindrical. When the driving plate 510 is rotated down to lock the cover 200, the driving plate 510 is accommodated in the first step slot 230 and parallel with the bottom face of the receiving groove 202, which make the thermal cup more beautiful.

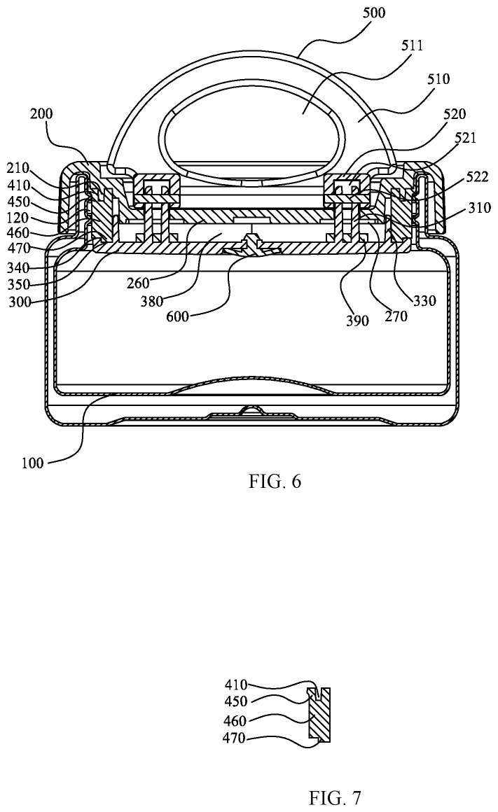

Referring FIG. 1, FIG. 3 and FIG. 6, the promoter 300 is installed at the bottom face of the receiving groove 202, the top portion of the promoter 300 is provided with a avoiding groove 380 for avoiding the receiving groove 202.

Referring FIG. 4 and FIG. 6, the driving plate 510 is semicircular, and the driving plate 510 is provided with a circular or elliptical through hole 511 at its middle, which is convenient for the users to rotate the driving plate 510 with their fingers to buckle the driving plate 510.

Referring to FIG. 1 and FIG. 3, at least one elastic member 120 is arranged between the receiving groove 201 and the promoter 300. Preferably, the number of the elastic member 120 is two. The elastic member 120 is a circular silica gel column with excellent elasticity. The promoter 300 is provided with a pair of first mounting grooves 381 at the avoiding groove 380, and two second mounting grooves (not shown) which are correspondence with the two first mounting grooves 381 are arranged on the bottom face of the receiving groove 201. Two ends of the elastic member 120 are respectively inserted the first mounting groove 381 and the second mounting groove. The elastic member 120 acts as a spring, when the cover 200 is locked, the elastic member 120 is in a compressed state, and when the cover 200 is opened, the elastic member 120 resets to push the promoter 300 down, so that the promoter 300 moves down smoothly and prevents the promoter 300 from being stuck so that the cover 200 cannot be opened.

Referring to FIG. 1 and FIG. 6, the bottom of each of the pushing rod 310 is provided with a gasket 390. Correspondingly, the cover 200 is provided with a gasket mounting groove 270 in each of the through-holes 220. When the driving plate 510 is rotated down to lock the cover 200, the gasket 390 contacts with the gasket mounting groove 270, so that the through-hole 220 is sealed and the heat-insulating effect of the thermal cup is better.

Referring to FIG. 1 and FIG. 3, the middle of the promoter 300 is provided with a one-way exhaust valve 600. The one-way exhaust valve 600 has an elastic valve portion 610. The upper portion of the elastic valve portion 610 has a column 620 with a limiting portion 621 at its top. The middle of the promoter 300 is provided with a connecting hole 360. Both sides of the connecting hole 360 are provided with a pair of air holes 370. The column 620 is inserted the connecting hole 360 with the limiting portion 621 connecting with the promoter 300. The elastic valve portion 610 contacts with the bottom face of the promoter 300 and cover the two air holes 370.

When the internal air pressure of the cup body 100 is less than the external air pressure, the driving plate 510 is turned upward to open the cover 200, and the external gas will enter through the through hole 220 and push the elastic valve portion 610 through the air holes 370 to form a gap between the elastic valve portion 610 and the promoter 300, from which the external gas enters the inside of the cup body 100, thereby balancing the internal and external pressure of the cup body 100, preventing the cover 200 from being unable to open. When the internal air pressure of the cup body 100 is greater than the outside air pressure, the driving plate 510 is rotated downward to lock the cover 200, and the inner space of the cup body 100 is instantaneously enlarged due to the moving-up of the promoter 300, so that the internal pressure of the cup body 100 is reduced, the cover 200 is prevented from being pushed out during the locking process.

Referring to FIG. 4, the thermal cup also includes an outer cover 700. The outer cover 700 covers the opening 101 of the cup body 100, and the cover 200 is located within the outer cover 700. The outer cover 700 can be used as a bowl.

Preferably, the sealing ring 400 is made of silica or rubber.

Referring to FIG. 6 and FIG. 7, in another embodiment of the present invention, the seal ring 400 includes a second annular connecting portion 450. The second annular connecting portion 450 is connected to the top wall of the cover 200. Specifically, the top portion of the second annular connecting portion 450 is provided with the first annular connecting groove 410. Preferably, the first annular protrusion 210 is inserted the first annular connecting groove 410 with its interference fit so that the sealing ring 400 is stably connected with the top wall of the cover 200. The second annular connecting portion 450 extends downward to form the second annular sealing portion 460. The promoter 300 has a connecting portion 330. The second annular sealing portion 460 is adapted to be fitted to the connecting portion 330. The second annular sealing portion 460 is bent to seal the gap under the push of the promoter 300.

Preferably, the lower end of the second annular sealing portion 460 is provided with a second annular connecting protrusion 470. The promoter 300 has a stepped groove 340 outside the connecting portion 330. The second annular connecting protrusion 470 is inserted the stepped groove 340 with its interference fit so that the sealing ring 400 is stably connected with the promoter 300.

Referring to FIG. 5, the inner wall of the opening 101 of the cup body 100 is provided with a sealing groove 120. The driver 500 drives the promoter 300 to move up, and the second annular connecting portion 450 is pressed to seal the gap among the opening 101, the promoter 200 and the top wall of the cover 200, and the sealing groove 120 is sealed. So that so that the inside of the cup body 100 is sealed and the heat preservation is realized. Similarly, the driver 500 drives the promoter 300 to move down, and the second annular connecting portion 450 flexibly resets so that the cover 200 can be opened from the opening 101 of the cup body 100.

The above is a further detailed description of the invention in combination with a specific preferred embodiment, and it cannot be concluded that the specific implementation of the invention is limited to these instructions. For the general technical personnel in the technical field to which the invention belongs, without being separated from the conception of the invention, the architecture form can be flexible and changeable, and a series of products can be derived. If it is just making a number of simple deductions or substitutes should be regarded as falling within the scope of patent protection determined by the claim submitted by the present invention.

What is claimed is:

1. A thermal cup, comprising:
a cup body with an opening;
a cover with a side wall and a top wall and covered to the opening, said top wall has a top face and a bottom face;
wherein also comprising:
a driver, installed on said top face of said top wall;
a promoter, installed on said bottom face of said top wall, said promoter passes through the top wall to connect with said driver; and
a sealing ring, made of elastic material and arranged between the cover and the promoter;
when said cover covers at said opening, said promoter is inside said opening, and a gap is formed among its inner wall of said opening, said top wall of said cover and said promoter, said sealing ring is accommodated in said gap; when it needs to close said cover, said driver is rotated to bring said promoter to move upwards, said gap is reduced and said sealing ring is bent to seal said gap so that said cover and said opening are sealed connection; when it needs to open the cover, said driver is rotated reversely to bring said promoter to move downwards, said sealing ring elastically resets to break said sealed connection of said opening and said cover.

2. The thermal cup according to claim 1, wherein said sealing ring includes a first annular connecting portion which is connected with said bottom face of said top wall of said cover, said first annular connecting portion extends downward to form a first annular sealing portion, and its outer diameter of said promoter is gradually reduced from its bottom to its top to form a tapered pushing portion, said tapered pushing portion contacts with its inner side of said first annular sealing portion; said first annular sealing portion is bent under push of said tapered pushing portion to seal said gap.

3. The thermal cup according to claim 2, wherein its outer wall of said first annular sealing portion is provided with a first sealing groove, and its inner wall of said opening is provided with an arc-shaped convex part; said first sealing groove is sealed connection with said arc-shaped convex part under push of said tapered pushing portion.

4. The thermal cup according to claim 2, wherein its top of said sealing ring is provided with a first annular connecting groove, its top wall of said cover is provided with a first annular connecting projection inserted said first annular connecting groove.

5. The thermal cup according to claim 1, wherein said sealing ring includes a second annular connecting portion which contacts to said bottom face of said top wall of said cover; said second annular connecting portion extends downward to form a second annular sealing portion; said promoter has a connecting portion; said second annular sealing portion is adapted to said connecting portion; said second annular sealing portion is bent under push of said promoter to seal said gap.

6. The thermal cup according to claim 5, wherein its lower end of said second annular sealing portion is provided with a second annular connecting protrusion; said promoter has a stepped groove outside said connecting portion; said second annular connecting protrusion is inserted said stepped groove 340 with its interference fit.

7. The thermal cup according to claim 2, wherein its top of said first annular connecting portion extends outwards to form an annular sealing table, its top face of said annular sealing table contacts with said bottom face of said top wall of said cover; when said cover covers said opening, its bottom face of said ring sealing table contacts with said opening.

8. The thermal cup according to claim 1, wherein at least one elastic member is arranged between said bottom top wall of said cover and said promoter.

9. The thermal cup according to claim 1, wherein said driver has a driving plate, one end of said driving plate is provided with two mounting seats enclosed by a connecting plate and two side plates arranged on both sides of the connecting plate; said two side plates are provided with a pair of eccentrical holes; a shaft is inserted the pair of eccentrical holes and arranged in parallel with the driving plate; one side of two side plates is far to the shaft to form a distal shaft side, the other side of the two side plates is near to the shaft to form a near shaft side; said promoter is provided with two pushing rods, and its upper portion of the pushing rod is provided with a hole; said shaft is rotatably connected to said hole; when it is need to lock said cover, the driving plate is rotated down to drive said distal shaft side to contact with said top face of said cover, so that the pushing rods is moved upward to push said sealing ring to seal said gap; when it needs to open said cover, said driving plate is rotated upward to drive said near shaft side to contact with said top face of said cover, so that said pushing rod is moved downward, said sealing ring resets, thereby unlocking the sealed connection of said cup body and said cover.

10. The thermal cup according to claim 9, wherein said distal shaft face and said near shaft face are perpendicular to each other; said distal shaft side is parallel to said driving plate, and said near shaft side is perpendicular to said driving plate.

11. The thermal cup according to claim 9, wherein said top wall of said cover is depressed to form a receiving groove, and said receiving groove is provided with a first step groove and a second step groove slot arranged up and down; the second step groove is provided with two through holes; said upper portions of said pushing rods are respectively movable through said two through holes and rotatably connected to said shaft.

12. The thermal cup according to claim 9, wherein said driving plate is semicircular, and said driving plate is provided with a circular or elliptical through hole.

13. The thermal cup according to claim 1, wherein said promoter is provided with at least one pushing rod at its upper end, said pushing rod is movable through said cover to connect with said driver.

14. The thermal cup according to claim 1, wherein its middle of said promoter is provided with a one-way exhaust valve.

15. The thermal cup according to claim 1, wherein said thermal cup also includes an outer cover, said outer cover is covered to said cup body, and said cover is located within said outer cover.
